(19) United States
(12) Patent Application Publication
(10) Pub. No.: US 2017/0190394 A1
(43) Pub. Date: Jul. 6, 2017

(54) Break Resistant Composite Stringer System

(71) Applicant: Kwong Kee Cheung, Shatin (HK)

(72) Inventor: Kwong Kee Cheung, Shatin (HK)

(21) Appl. No.: 15/257,721

(22) Filed: Sep. 6, 2016

(30) Foreign Application Priority Data
Dec. 31, 2015 (CN) 201511014653.6
Dec. 31, 2015 (CN) 201521123987.2

(51) Int. Cl. B63B 35/79; B32B 7/12; B32B 27/30; B32B 5/18

(52) U.S. Cl. CPC B63B 35/7906; B32B 5/18; B32B 7/12; B32B 27/302; B32B 2266/0228

(57) ABSTRACT

The invention relates generally to sports boards, and more particularly to a break resistant composite stringer system for surfboards. The composite stringer system comprises a stringer body and fibrous strips adhered on the top surface and/or bottom surface of the stringer body. The invention relates in particular to a surfboard equipped with the present composite stringer system for preventing board breaking, whereas the surfboard exhibits high stiffness, flex recovery and fracture resistance, and thus enhancing safety for surfboard riders. A stringer body has a top surface and a bottom surface and fibrous strips are adhered to the top surface or the bottom surface of the stringer body. A second fibrous strip is adhered to the outer surface of the first fibrous strip.

The present invention claims priority from China application 201521123987.2 filed Dec. 31, 2015 under the same inventor Kwong Kee Cheung, entitled Break Resistant Composite Stringer System and surfboard the disclosure of which is incorporated herein by reference.

The present invention claims priority from China patent application 201511014653.6 also filed Dec. 31, 2015 under the same inventor Kwong Kee Cheung, entitled Break Resistant Composite Stringer System and surfboard the disclosure of which is incorporated herein by reference.

### FIELD OF THE INVENTION

This invention relates generally to sports boards, and more particularly to surfboards equipped with a break resistant composite stringer system.

### BACKGROUND OF THE INVENTION

Surfboards are recreational sporting goods and helpful equipment for surfing in the ocean. Surfboards are typically ridden in a stand up position during surfing. Therefore surfboard structures are necessary reinforced to achieve high stiffness and break resistance. In general, surfboard structures can be divided into two main categories according to surfboard structures and production technology: fiberglass surfboards and non-fiberglass surfboards.

Typical type one fiberglass surfboard manufacture utilises a light density foam blank encased on both the deck surface and bottom surface with a hard coating of fiberglass cloth and resin. This type of surfboard has a hard surface and is usually referred as hard surfboard. Typical foam materials include expanded polystyrene foam (EPS) and polyurethane foam (PU). The foam blank can incorporate a stringer system for controlling flex and reinforcing strength of entire surfboard. Typically a centerline stringer, formed of balsa wood, is sandwiched between two halves of foam blank. Other stiffening materials suitable for stringers may include metal tubes, fiberglass tubes and carbon fiber tubes. In general, the design of reinforcing stringer tubes has a cross-section of round shape or other hollow profile shapes for the purpose of weight reduction.

Conventional stringer system may provide an I-Beam stringer, as such a shape greatly increases the lateral breaking resistance of the surfboard into which it is installed. Although an I-beam made of aluminum, or fibrous materials may be more desirable in terms of strength, the heavy weight and high cost of such an I-Beam makes them prohibitive. In addition, the manufacture of I-Beam stringer in a bow shape is unnecessarily complex and expensive.

### SUMMARY OF THE INVENTION

The present invention relates generally to sports board such as a surfboard. This present invention seeks to solve the above problems by providing a break resistant composite stringer system and surfboard. The composite stringer system exhibits higher stiffness and flex recovery and therefore the surfboard is more fracture resistant, greatly enhancing safety for surfboard riders. The present invention provides a break resistant composite stringer system, comprising: a stringer body and fibrous strips adhered on the top surface and/or bottom surface of the stringer body. Preferably, the stringer body has at least one upturning end whereas the fibrous strips extend to the two ends of the stringer body and adhere thereon. Preferably, the fibrous strips have a length equal or shorter than the stringer body. Preferably, the width of the fibrous strips has a dimension larger than the thickness. Preferably, a first layer of heat resistant waterproof adhesive resin is bonded between the fibrous strips and the stringer body. Preferably, after the fibrous strips being bonded to the stringer body by the first layer of heat resistant adhesive layer, the entire composite stringer is covered with a second layer of waterproof adhesive. Preferably, the stringer body has a width in the range of 8 mm to 18 mm. Preferably, the fibrous strips has a thickness in the range of 0.6 mm to 2 mm.

The present invention includes a break resistant surfboard equipped with the above break resistant composite stringer system, having a foam core, a stringer system evenly distributed within the foam core, and a top laminated foam skin covering the top and side rail surface of the foam core. The top laminated foam skin has at least one layer of expanded foam. A bottom laminated foam skin covers the bottom surface of the foam core. The bottom laminated foam skin has at least one layer of expanded foam and a non-foaming plastic plate is laminated to the outer surface of the bottom foam skin. The stringer is a break resistant composite stringer system. The break resistant stringer system has a length shorter than the foam core.

The break resistant composite stringer system includes a stringer body having a stringer top surface and stringer bottom surface, an upper fibrous strip adhered to the stringer body at the stringer top surface, and a lower fibrous strip adhered to the stringer body at the stringer bottom surface. The stringer body, upper fibrous strip and the lower fibrous strip form a composite stringer. The second upper fibrous strip is adhered to stringer top surface, and a second lower fibrous strip is adhered to the stringer lower surface.

The stringer body has a front end and a rear end. The front end or the rear end is upturned so that it is an upturned end. The upper fibrous strip is adhered to the stringer body from the front end to the rear end and the lower fibrous strip is adhered to the stringer body from the front end to the rear end. The upper fibrous strip and the lower fibrous strip both have a length equal or shorter than the stringer body. The upper fibrous strip and the lower fibrous strip have a fibrous strip width dimension larger than a fibrous strip thickness dimension. An upper fibrous strip adhesive layer is formed of a heat-activated rubber based adhesive. The upper fibrous strip adhesive layer is a heat resistant and waterproof adhesive layer interposed between the upper fibrous strip and the stringer top surface. A lower fibrous strip adhesive layer is formed of a heat-activated rubber based adhesive. The lower fibrous strip adhesive layer is a heat resistant and waterproof adhesive layer is interposed between the lower fibrous strip and the stringer bottom surface.

The second layer of heat resistant waterproof adhesive can cover the fibrous strips and stringer body after the fibrous strips are bonded to the stringer body to form a composite stringer. The stringer body can have a width in the range of 8 mm and 18 mm. The upper fibrous strip and the lower fibrous strip both have a thickness in the range of 0.6 mm and 2 mm.

The break resistant composite stringer can be made as a surfboard or sports board by adding a foam core having a foam core top surface, a foam core bottom surface, a foam core right surface and a foam core left surface. A composite stringer channel formed in the foam core, wherein the composite stringer channel is configured to receive the composite stringer. A top laminated foam skin covers the foam core top surface, the foam core right surface and the foam core left surface. The top laminated foam skin includes at least one layer of expanded foam. A bottom laminated foam skin covers the foam core bottom surface. The bottom laminated foam skin has at least one layer of expanded foam. A plastic plate is laminated to a lower surface of the bottom laminated foam skin. The composite stringer can be shorter than the foam core.

The present invention has the following advantages:
1. The fibrous strips adhered on the top surface and/or bottom surface of the stringer body are relatively thin and therefore flexible, allowing the strips to bend and extend to the two ends of the stringer body and maintain intimate contact with the curved surface of the stringer body. The fibrous strips provide reinforcement to stiffen the stringer. Nevertheless the fibrous strips are relatively thin and the weight of the two strips adds very little weight to the stringer.
2. The tensile strength of fibrous strip is higher than the stringer body. When the fibrous strips are bonded to the stringer body as a unified body, the fibrous strips can greatly inhibit the deformation of the stringer body in the vertical direction.
3. The fibrous strip has a cross-sectional shape of rectangle, the width being larger than the thickness. When the fibrous strips are bonded to the stringer body as a unified body, the fibrous strips can greatly inhibit the deformation of the stringer body in the transverse direction and therefore significantly increase the breaking strength of the stringer body.

### BRIEF DESCRIPTION OF THE DRAWINGS

FIG. 1 is a side view of the stringer system, illustrating the primary assembly step.

FIG. 2 is a perspective view of the stringer system, illustrating the primary assembly step.

FIG. 3 is a side view of the stringer system after the primary assembly step.

FIG. 4 is a top plan view of the stringer system after the primary assembly step.

FIG. 5 is a perspective view of the stringer system after the primary assembly step.

FIG. 6 is a top plan view of a preferred embodiment of surfboard, illustrating the placement of stringer system inside the surfboard.

FIG. 7 is a cross-sectional view of the preferred embodiment of surfboard, taken generally along the longitudinal direction of the surfboard.

FIG. 8 is a cross-sectional view of the preferred embodiment of surfboard, taken generally along the transverse direction of the surfboard.

FIG. 9 is a partial cross-sectional view of preferred embodiment of surfboard, taken generally along the longitudinal direction of the surfboard.

FIG. 10 is a cross-sectional view of the stringer system, illustrating the dimensions of stringer body and fibrous strip.

FIG. 11 is an exploded cross-sectional view of another preferred embodiment of the stringer system.

FIG. 12 is a cross-sectional view of a conventional fiberglass hard surfboard, taken generally along the transverse direction of the surfboard.

The following call out list of the elements can be a useful guide in referencing the element numbers of the drawings.
1 reinforcing stringer
2 surfboard
11 stringer body
12 fibrous strips
13 upper fibrous strip
14 lower fibrous strip
15 composite stringer channel
21 foam core
22 foam skin
23 plastic plate
24 inner bottom foam layer
25 outer bottom foam layer
26 foam core top surface
27 foam core bottom surface
28 foam core right rail surface
29 foam core left rail surface
31 stringer right surface
32 stringer left surface
33 stringer top surface
34 stringer bottom surface
35 rebound clips
36 stringer front end
37 stringer rear end
38 surfboard front end
39 surfboard rear end
41 second upper fibrous strip
42 second lower fibrous strip
43 upturned end
44 fibrous strip width dimension
45 fibrous strip thickness dimension
46 upper fibrous strip adhesive layer
47 lower fibrous strip adhesive layer
48 second layer of heat resistant waterproof adhesive
49 stringer body width dimension
51 foam core of a conventional hard surfboard
52 deck skin of a conventional hard surfboard
53 bottom skin of a conventional hard surfboard
54 wood stringer of a conventional hard surfboard

### DETAILED DESCRIPTION OF THE PREFERRED EMBODIMENT

### Glossary

Sports board: a board used in a sport where the user rides on the board and includes surfboards, sail boards or windsurf boards, wakeboards, wake skates, body boards and snow boards.

Surf board: a sports board used for riding waves.

Stringer: a resilient and flexible elongated support member

Composite stringer: a stringer made of more than one kind of material

A cross-sectional view of a typical hard surfboard reinforced by fiberglass layers is illustrated in FIG. 12. The foam core 51 is typically an expanded polystyrene foam (EPS) or polyurethane foam (PU). The reinforcing stringer 54 is typically a rectangular cross-section wood strip. The deck skin 52 and the bottom skin 53 are both a layer of conventional fiberglass cloth and resin coating, forming a structure of hard shell on the outer surfaces of the surfboard. Carbon fiber or other high strength synthetic fibers may be use to replace fiberglass for more light weight and high strength surfboards. Both the top edge and bottom edge of the wood stringer are connected to the resin coating of the top surface and bottom surface of the surfboard. In general, the wood strip stringer has a thickness typically in the range of 5 mm and provides minor role to the strength of surfboard. The strength of hard surfboard is mainly contributed by the hard shell of fiberglass cloth and resin.

Type two non-fiberglass surfboards usually do not utilize any resin impregnated fibers in the layered structure. Typically, this type of surfboard comprises a bottom non-foam plastic plate and a deck foam skin. The surfboards have a soft foam skin on the deck and therefore are usually referred as soft surfboards. This type of surfboards is usually not reinforced by any hard coating of fiberglass resin on the outer surface. Therefore the strength of surfboard depends very much on the stiffness of stringer system within the foam core. As a result, the stringer of a soft surfboard is usually made into a bow shape to conform to the profile of a surfboard having an upturning front section and an upturning tail section, which are commonly called the nose rocker and tail rocker of a surfboard. Continuous extruded fiberglass sheet or tube produced by conventional protrusion process can only make linear straight fiberglass sheet and fiberglass tube. When incorporating fiberglass sheet or tube into a surfboard foam core as stringers, these stringers cannot extend to the ends of the nose rocker and the tail rocker. The two ends of surfboard are therefore more prone to breaking, in particular in the case of long surfboards. Although there are specialized production methods to manufacture custom shape fiberglass products by molding, the considerable hand labor results in high cost. The manufacture process is complex and tooling cost is expensive. Thus, these production methods are not employed in manufacturing fiberglass stringers for surfboards.

Stringer materials for soft surfboard are usually selected from resin laminated bamboo board, plywood board and timber board and these boards are cut to the shape of stringers. Plywood, oriented strand board or other engineered lumber product incorporate oriented strands of wood fiber bonded with an adhesive and cured in a hot platen press. In the case of bamboo board, segments of bamboo are bonded with an adhesive and cured in a hot platen press. It has been an old art to use plywood or hard wood boards as the materials for stringers for many years. In general, the cross-section of wood stringer is designed having the dimension in the vertical direction larger than that of the horizontal direction. In this way, the resulting stringer exhibits a higher flexural strength in the vertical direction under the same material weight. Unlike the hard surfboard, wood stringer of soft surfboard cannot extend to the bottom surface or the top surface of the foam core. The top skin and bottom skin are layer structure of flexible foam sheets which are prompted to permanent deformation by collapse of foam cells under prolonged compression force against the hard wood stringer. As a result, wood stringers of soft surfboard are usually encapsulated by the foam core and therefore the height of wood stringers in the vertical direction is limited by the thickness of surfboard foam core. This in terms limits the design of using a wood stringer having a height dimension in the vertical direction same as the thickness of foam core in a soft surfboard. Therefore it is desirable to provide soft surfboards with stringer system of higher flexural strength in the vertical direction under the same dimensions of stringers.

The impact from large waves can cause board breaking problems. Such impacts will trigger the stringer to deform in both the vertical direction and the lateral direction. If the impact forces are strong enough and exceed the breaking strength of the wood stringer either in the vertical direction or the lateral direction, the surfboard fails by fracture and may cause hazard to user. A typical wood stringer in a soft surfboard has a width dimension less than the height and therefore such a stringer provides little resistance to such flexing in the lateral direction and has maximum bending moment roughly at the middle section of the stringer. Therefore surfboards are rarely broken longitudinally. Instead, soft surfboards typically fail by fracture in the lateral direction roughly at the middle section of the stringer. The fracture problem is caused by the lower flexural strength of stringers made from plywood board, timber board and resin laminated bamboo board compared to fibrous materials. The flexural strength of stringer can be effectively improved to avoid board fracture if, for example, the thickness (horizontal direction) of the stringer is increased. However such a change will considerably increase the weight of stringer and is not favorable for the surfboard application. It is desirable to provide surfboards with improved lateral stiffness and break resistant property to enhance durability of the boards particularly in harsh wave conditions. There is a need for an improved stringer system which greatly increases the stiffness and breaking strength of surfboard and such a system would not significantly increase the cost or complexity of manufacturing such a surfboard.

Surfboard is required to flex a desired amount and at desired locations. Conventional hard surfboards generally have a wood stringer positioned at a longitudinal centerline and the top edge and the bottom edge of the wood stringer are bonded to the hard fiberglass resin coating on the top and bottom surfaces of the foam core. Such surfboard has a hard shell and can cause injury to riders and therefore only suitable for experience riders. Soft surfboard equipped with plywood stringers is undesirable in the flex patterns because it has too little flex. Therefore, it is desirable to provide a soft surfboard with selected or predetermined desired flex patterns at desired locations, which ultimately enhances maneuverability and performance of the board to the rider.

Soft surfboards are originally designed for beginner users. However there are demands for performance soft surfboards designed for more experienced surfers. These performance soft boards are lighter and in most cases have a thinner foam core than conventional soft surfboards. As the foam core is thin, the height of stringers is further limited, affecting the stiffness of the surfboard. It is therefore desirable to provide a soft surfboard with a high stiffness stringer within a thin foam core.

Wood stringers have an inherent problem of high water absorption, leading to degradation and breakage of the stringers. During service of a surfboard, there are opportunities of water invasion from the fin holes seeping into the core of foam blank. The water invasion results in degradation and breakage of the stringers. Therefore there is a need for applying a waterproof coating to cover the surface of wood stringers, for preventing water absorption.

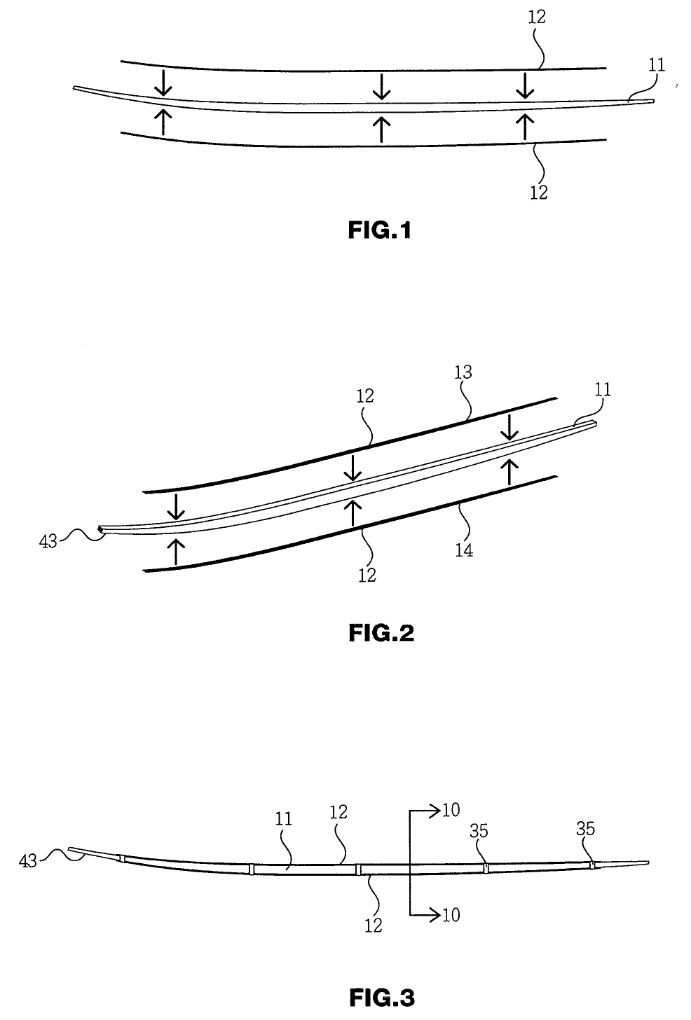

In the preferred embodiment shown in FIGS. 1-2, the break resistant composite stringer system of the present invention, comprising: a stringer body 11 and fibrous strips 12. The fibrous strips 12 may be adhered only on the top surface or bottom surface of the stringer body 11. In an alternate embodiment, the fibrous strips 12 may be adhered on both the top surface and bottom surface of the stringer body 11. The stringer body 11 may be formed in a linear configuration. The stringer body 11 may has one upturning end or two upturning ends.

In the preferred embodiment shown in FIGS. 1 and 2, the first preferred embodiment includes a stringer body 11 having one upturning end. Both the top surface and bottom surface of the stringer body 11 are equipped with fibrous strips 12, whereas the fibrous strips 12 adhere to the curved surface of the stringer body 11. The stringer body 11 is formed from high strength materials selected from timber board, plywood board, resin laminated bamboo board, metal tube, plastic board and honeycomb board. Preferable stringer materials are plywood board and resin laminated bamboo board. The stringer body can be made of a laminate wooden structure such as plywood. The plywood optionally includes composite lamination reinforcement within the stringer body 11.

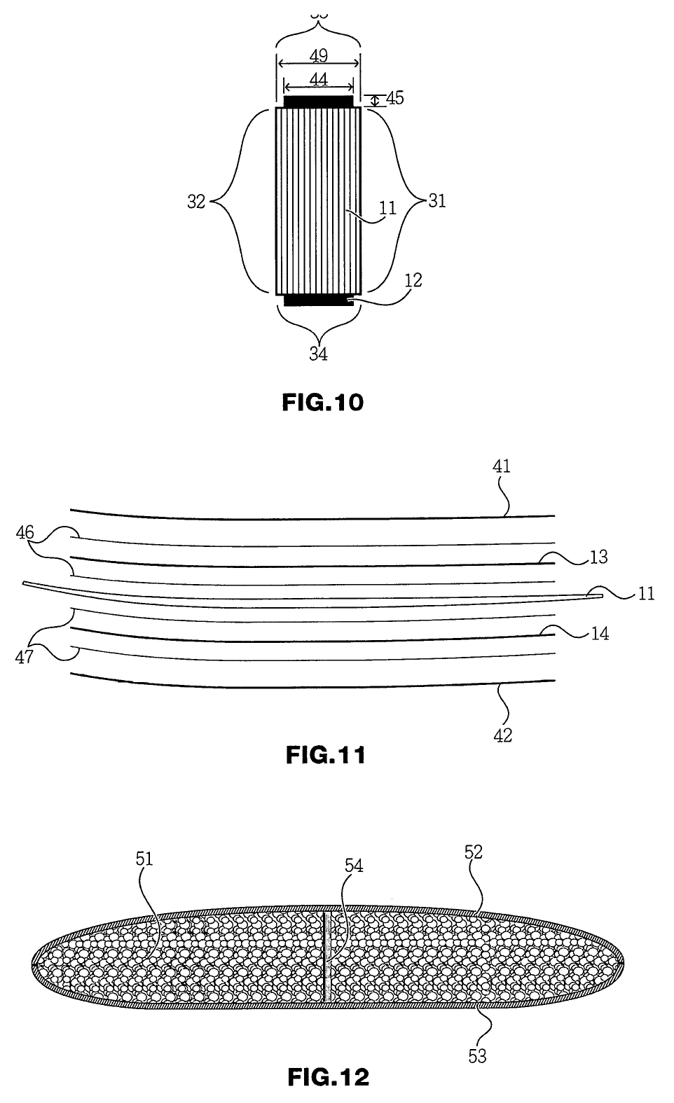

The stringer body 11 is reinforced by fibrous strips. Fibrous strips 12 are formed from synthetic fibrous materials, selected from fiberglass, carbon fiber, other synthetic fibrous materials or mixtures thereof. As illustrated in FIG. 10, the width 44 of fibrous strips 12 has a dimension larger than the thickness 45. The fibrous strip has a cross-sectional shape of rectangle, parallelogram or triangle, more preferable a rectangular cross-section. The strength of the stringer system is mainly contributed by the stringer body 11. The application of fibrous strips 12 on the top and bottom surfaces of the stringer body 11 increases the flexural strength of the stringer system in both the vertical direction and the transverse direction.

As illustrated in FIG. 10, the fibrous strips 12 may have a width equal to or less than the stringer body 11. For requirement of higher flexural strength of the stringer system in the transverse direction, fibrous strips may have a width larger than that of the stringer body 11. The fibrous strips may have a greater thickness to stiffen the stringer system. However the weight of fibrous strip increases with thickness. An optimum stringer system is a balance between strength and weight. Furthermore, a fibrous strip with thicker cross-section is less flexible and therefore cannot bended to maintain intimate contact with the curved surfaces, in particular at the two ends of the stringer body 11. In another preferred embodiment shown in FIG. 11, more than one fibrous strip, for example one strip laid on top of another strip, may be applied to the top surface and/or the bottom surface of the stringer body to further increase the stiffness of the composite stringer system. Alternatively, the stiffness of the composite stringer system can be adjusted to the predetermined desired flex value by employing fibrous strips having different strength. For example, a carbon fiber strip has greater stiffening effect to the composite stringer than a fiberglass strip. The flexural strength of the fibrous strip may be further adjusted by altering the mixing ratio of carbon fiber and glass fiber inside the fibrous strip. For example, a fibrous strip with increased volume percentage of carbon fiber filaments than glass fiber filaments will produce a strip with higher flexural strength. Fibrous strips made from strands of monofilament fibers provide the maximum stiffness compared with fibrous strips made from woven fibers. The fibrous strips of the present stringer system are preferable made from strands of fiberglass monofilament because fiberglass strips have high stiffness and yet relative low cost. The fibrous strips 12 may have a length equal or shorter than the stringer body 11. The fibrous strips 12 should cover at least half the length of the stringer body 11. The tensile strength of fibrous strip 12 is higher than the stringer body 11. When the stringer body 11 is equipped with the fibrous strips 12 along the curved surface of the stringer, the stringer system has greatly improved its flex recovery characteristics. As the fibrous strips are securely bonded to the stringer body, the fibrous strips function like a spring to evenly distribute any impact force from waves. When the stringer body flex under bending force, the deformation has a stretching effect to the fibrous strips. The fibrous strips tend to resist the stretching action from the bending force due to its high tensile strength. The result is that the stringer body has less flex and spring back more quickly under impact force. In addition, surfboard with improved flex recovery is desirable for enhancing maneuverability and performance of the board to the rider. Furthermore, the fibrous strip has a cross-sectional shape of rectangle, the width being larger than the thickness. The fibrous strips 12 can greatly inhibit the deformation of the stringer body 11 in the transverse direction and therefore significantly increase the breaking strength of the composite stringer in the transverse direction. Consequently, the stringer is less prone to breaking, enhancing the safety of the surfboard.

The stringer body 11 and the fibrous strips 12 have to be securely bonded together as a unified body in order to ensure that there is no relative movement between the two parts under an external mechanical force. The two components may be bonded by adhesive, screws, rivets, tie straps or other mechanical fasteners. It is desirable to have the entire interface between the fibrous strips and the stringer body tightly bonded together as a unified body. Preferred bonding method is using adhesive. The adhesive used for bonding the composite stringer should exhibit good wetting property to facilitate good adhesion contact between the strips and the stringer body. In addition, the adhesive should demonstrate high bond strength, good toughness and elasticity to tolerate the flex of stringer system induced by the high impact force of ocean wave. Adhesives derived from thermoplastic elastomers with heat resistant and waterproof properties are desirable for the present application. Good heat resistance is important in the application of surfboards because they are exposed directly to sunlight.

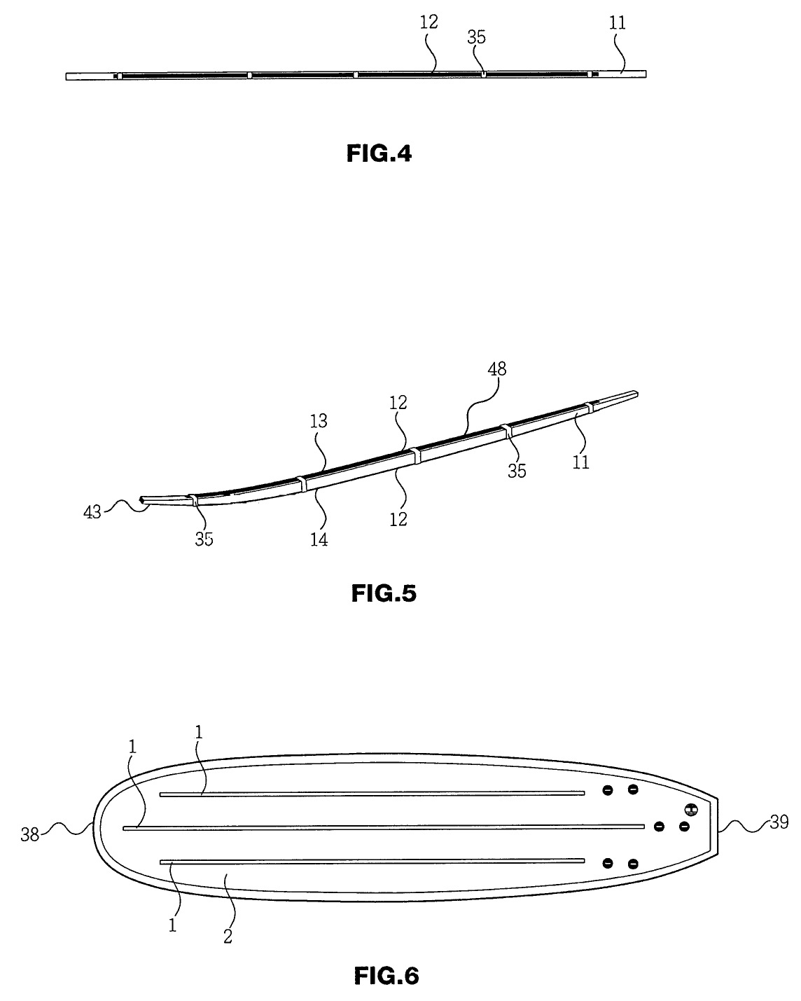

A heat resistant waterproof adhesive is applied between the fibrous strips 12 and the stringer body 11, forming the first heat resistant waterproof adhesive layer. The preferred manufacturing process is: Applying a layer of heat resistant waterproof adhesive to the top surface and bottom surface of the stringer body 11. The melting point of the heat resistant adhesive should be minimum 60° C. The fibrous strips 12 are adhered respectively to the top surface and bottom surface. As shown in FIGS. 3, 4 and 5 several surrounding tapes are applied to temporary fasten the fibrous strips 12 onto the stringer body 11 at suitable separation intervals.

In order to improve waterproof property of stringer and increase the bonding between the stringer and the foam core, the entire composite stringer is coated with a second layer of heat resistant waterproof adhesive resin after the fibrous strips 12 being bonded to the stringer body 11 by heat resistant waterproof adhesive layer. The second adhesive layer bonds the composite stringer to the foam core as a unified body. As a result, the second adhesive layer has the function to prevent the stringer from absorbing water and improve the stiffness of the surfboard.

Solid content influences the inherent strength of the adhesive film. However high solid content adhesive solution exhibits high viscosity and does not provide satisfactory wetting property to the bonding interface. A heat-activated rubber based adhesive is used in the present invention to overcome such a bonding problem. The adhesive is preferable derived from synthetic rubber, including but not limited to Styrene Butadiene Rubber (SBR), Acrylonitrile Butadiene Rubber (NBR), Polychloroprene Rubber (CR), Polybutadiene Rubber (BR), Polyisoprene Rubber (IR), Polyurethane (PU) and other hot melt adhesives available in the market. Polychloroprene based adhesive is more preferable in the present invention.

For example, both substrates are coated with adhesive, allowed to dry and then combined under light pressure. The polychloroprene adhesive provides immediate green strength. The assembled components of the stringer body and the fibrous strips can undergo finishing operations without additional clamping or fixturing. Crystallization of polychloroprene is reversible and temperature dependent. In the foaming process of surfboard foam core, the assembled composite stringers are placed inside the foam core mold. After the EPS foam beads are injected into the mold cavity of the surfboard core, superheated steam is passed into the mold cavity to expand the foam beads. The polychloroprene adhesive de-crystallizes at elevated temperatures and turns into low viscosity resin. The adhesive resin can diffuse into any gaps or interfaces between the stringer body and the fibrous strips at high temperature condition inside the mold cavity. After cooling, polychloroprene adhesive provides high ultimate bond strength and exhibits excellent toughness and peel strength. Unlike chemical crosslinking adhesives, such as epoxy, polychloroprene adhesive remains resilient after complete curing. Polychloroprene also demonstrates both heat resistance and waterproof characteristic.

During manufacture of the stringer system, the stringer body 11 is made at a width 49 in the range of 8 mm to 30 mm and more preferable in the range of 8 mm to 18 mm. The fibrous strips 12 has a width 44 in the range of 5 mm to 25 mm and more preferable in the range of 5 mm to 15 mm. The fibrous strips 12 has a thickness 45 in the range of 0.6 mm to 5 mm and more preferable in the range of 0.6 mm to 2 mm. The fibrous strips 12 should be relatively thin and possess the characteristics of good flexibility and light weight. The fibrous strips are flexible and therefore allow the strips to maintain intimate contact with the curved surfaces at the two ends of the stringer body 11. The fibrous strips are light weight and therefore have little impact to the total weight of the stringer system. The present invention facilitates the production of composite stringer system with improved stiffness and break resistance at relatively low material and labor cost.

In an alternative embodiment 2, the fibrous strips 12 may be adhered only on the top surface of the stringer body 11. In another alternative embodiment 3, the fibrous strips 12 may be adhered only on the improvement in the flex recovery and flexural strength of the stringer. Various modifications can be made without departing from the spirit and scope of the invention. For example, the fibrous strips may be adhered on any desirable position of the stringer body and additional number of fibrous strips may be applied to the stringer body according to the requirement of mechanical properties.

As shown in FIGS. 6, 7, 8 and 9, the present invention discloses a break resistant surfboard 2, equipped with the composite stringers. The surfboard 2 comprises: a foam core 21, a break resistant composite stringer 1 evenly distributed within the foam core 21, a top laminated foam skin 22 covering the top surface 26 and side rail surfaces 28, 29 of the foam core 21, whereas the top laminated foam skin 22 comprising at least one layer of expanded foam, a bottom laminated foam skin covering the bottom surface of the foam core 21, whereas the bottom laminated foam skin comprising at least one layer of expanded foam and a non-foaming plastic plate 23 laminated to the outer surface of the bottom foam skin.

The bottom laminated foam skin includes a plurality of expanded foam layers. In general, the densities of the expanded foam layers increases from inside layer to outside layer for enhancing strength of the bottom structure of surfboard. The preferred embodiment shown in FIGS. 8 and 9 includes a bottom laminated foam skin formed by two layers of expanded foam. The two layers of expanded foam are respectively the inner bottom foam layer 24 which laminated to the bottom surface of the foam core 21 and the outer bottom foam layer 25 which laminated to the bottom surface of the inner bottom foam layer 24.

In the preferred embodiment, the foam core has a thickness between 13 mm and 150 mm and preferably a thickness between 25 m and 90 mm. The foam core has a density between 15 kg/m³ and 65 kg/m³ and preferably a density between 18 kg/m³ and 40 kg/m³. Suitable materials for use as foam core include expanded polystyrene foam (EPS), expanded polypropylene foam (EPP), expanded polyethylene foam (EPE), expanded polyolefin (EPO) and polyurethane foam (PU), whereas polystyrene foam is the preferred foam core material in the present embodiment. The top laminated foam skin has a thickness between 1 mm and 6 mm and preferably a thickness between 3 mm and 5 mm. The top laminated foam skin has a density between 45 kg/m³ and 176 kg/m³ and preferably a density between 56 kg/m³ and 128 kg/m³. Suitable materials for use as top laminated foam skin include polyethylene foam sheet (PE), polypropylene foam sheet (PP) and ethylene vinyl acetate copolymer foam sheet (EVA), whereas polyethylene foam sheet (PE) is the preferred top foam skin in the present embodiment. The bottom laminated foam skin has a thickness between 1 mm and 6 mm and preferably a thickness between 2 mm and 4 mm. The bottom laminated foam skin has a density between 27 kg/m³ and 128 kg/m³ and preferably a thickness between 38 kg/m³ and 104 kg/m³. Suitable materials for use as bottom laminated foam skin include polyethylene foam sheet (PE), polypropylene foam sheet (PP) and ethylene vinyl acetate copolymer foam sheet (EVA), whereas Polyethylene foam sheet (PE) is the preferred bottom foam skin in the present embodiment. The plastic plate has a thickness between 0.1 mm and 2 mm and preferably a thickness between 0.35 mm and 1.2 mm. Preferred materials for use as plastic plate include polyethylene and polypropylene.

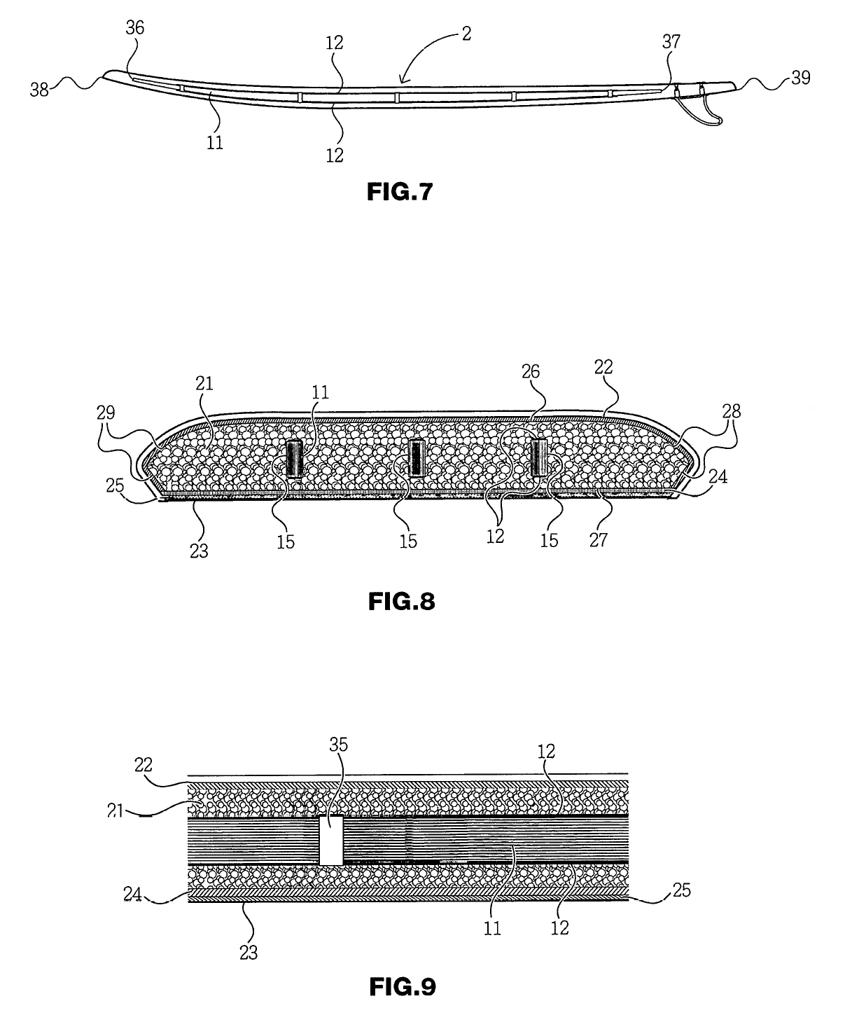

The break resistant composite stringer 1 as shown in FIGS. 6 and 7 has a length shorter than the foam core 21. In general, the surfboard 2 of the present invention is equipped with one to five such stringers. The length of the stringer in the center line of the board is usually longer than the stringers located at the two sides. The side stringers are symmetrically installed at two sides. Various modifications may be made whenever necessary. For example, the orientation of the stringers may be installed at an angle inclined with the center line of the surfboard to avoid hitting the fins and allow the stringers extending far enough to the end of tail region.

The foam core has a channel for receiving and encapsulating the stringer 1. The stringer 1 preferably has a stringer right surface 31 and a stringer left surface 32. The stringer right surface is bonded to the foam core 21 and the stringer left surface is bonded to the foam core 21. The stringer 1 also has a stringer top surface 33 and a stringer bottom surface 34. The fibrous strips 12 includes an upper fibrous strip 13 and a lower fibrous strip 14. The stringer top surface 33 bonded to the upper fibrous strip 13 which is bonded to the foam core 21 and the stringer bottom surface 34 is bonded to the lower fibrous strip 14 which is turn bonded to the foam core 21. The stringer top surface can be thermally laminated or adhered to the upper fibrous strip 13 and the stringer bottom surface can be thermally laminated or adhered to the lower fibrous strip 14.

The stringer 1 has a stringer front end 36 and a stringer rear end 37. The stringer front end 36 is at a surfboard front end 38 and the stringer rear end 37 is at a surfboard rear end 39. The stringer 1 is generally parallel to the surfboard 2. The stringer 1 may also have a stringer body 11 with an upturned end at either the stringer front end 36 or the stringer rear end 37.

The rebound clips 35 retain the layers of the stringer 1 together. The rebound clips can be formed of fiberglass wrapping where a strip of fiberglass is wrapped around the stringer right surface 31, the stringer top surface 33, the stringer left surface 32, and the stringer bottom surface 34. The rebound clips 35 are preferably spaced apart from each other at regular intervals along the length of the stringer 1. The stringer is a composite leaf spring. The first upper fibrous strip 13 can be laminated to a second upper fibrous strip 41 and the first lower fibrous strip 14 can be laminated to a second lower fibrous strip 42. The fiber orientation of the first upper fibrous strip 13 can be different than the fiber orientation of the second upper fibrous strip 41. Similarly, the fiber orientation of the first lower fibrous strip 14 can be different than the fiber orientation of the second lower fibrous strip 42.

The upper fibrous strip can be secured to the upper surface of the stringer with an upper fibrous strip adhesive layer 46. The lower fibrous strip can be secured to the lower surface of the stringer with a lower fibrous strip adhesive layer 47. The upper fibrous strip and the lower fibrous strip are in turn adhered to the foam core 21. The foam core has a foam core top surface 26 that opposes a foam core bottom surface 27. The foam core right rail surface 28 opposes the foam core left rail surface 29. The foam core 21 preferably includes one or more composite stringer channels 15 for receiving composite stringers. A plastic plate 23 can be directly laminated to the foam core bottom surface 27, or preferably the plastic plate 23 is laminated to a lower surface of the bottom laminated foam skin.

While the particular embodiments of the invention have been illustrated and described above, it will be apparent that various modifications can be made without departing from the spirit and scope of the invention. Accordingly, it is not intended that the invention be limited by such variations, modifications and improvements.

1. A break resistant composite stringer system comprising:
a. a stringer body having a stringer top surface and a stringer bottom surface;
b. an upper fibrous strip adhered to the stringer body at the stringer top surface;
c. a lower fibrous strip adhered to the stringer body at the stringer bottom surface, wherein the stringer body, the upper fibrous strip and the lower fibrous strip form a composite stringer, wherein both the upper fibrous strip and the lower fibrous strip have a cross-section that is either rectangular shaped, parallelogram shaped or triangular shaped, wherein a width of the upper fibrous strip is greater than a thickness of the upper fibrous strip and wherein a width of the lower fibrous strip is greater than a thickness of the lower fibrous strip, wherein the width of the upper fibrous strip and the width of the lower fibrous strip both have a width in the range of 5 mm to 25 mm, and wherein the thickness of the upper fibrous strip and the thickness of the lower fibrous strip are in the range of 0.6 mm to 5 mm, wherein the composite stringer system is encapsulated by the foam core, and wherein the strength of the stringer system is mainly contributed by the stringer body; and
d. a foam core receiving the stringer body, the lower fibrous strip, the upper fibrous strip and a top laminated foam skin comprising at least one layer of expanded foam covering a top surface and a side rail surface of the foam core.

2. The break resistant composite stringer system of claim 1, wherein a second upper fibrous strip is adhered to the stringer top surface, and wherein a second lower fibrous strip is adhered to the stringer lower surface.

3. The composite stringer system of claim 1, wherein the stringer body has a front end and a rear end, wherein the front end or the rear end is upturned so that it is an upturned end; wherein the upper fibrous strip is adhered to the stringer body from the front end to the rear end and wherein the lower fibrous strip is adhered to the stringer body from the front end to the rear end.

4. The composite stringer system set forth in claim 1, wherein the upper fibrous strip and the lower fibrous strip both have a length equal or shorter than the stringer body.

5. The composite stringer system set forth in claim 1, wherein the upper fibrous strip and the lower fibrous strip have a fibrous strip width dimension larger than a fibrous strip thickness dimension.

6. The composite stringer system set forth in claim 1, further including: an upper fibrous strip adhesive layer formed of a heat-activated rubber based adhesive wherein the upper fibrous strip adhesive layer is a heat resistant and waterproof adhesive layer interposed between the upper fibrous strip and the stringer top surface; and a lower fibrous strip adhesive layer formed of a heat-activated rubber based adhesive wherein the lower fibrous strip adhesive layer is a heat resistant and waterproof adhesive layer interposed between the lower fibrous strip and the stringer bottom surface.

7. The composite stringer system set forth in claim 6, wherein a second layer of heat resistant waterproof adhesive covers the fibrous strips and stringer body after the fibrous strips are bonded to the stringer body to form a composite stringer.

8. The composite stringer system set forth in claim 1, wherein the stringer body has a width in the range of 8 mm and 30 mm.

9. (canceled)

10. The composite stringer system set forth in claim 1, wherein the break resistant composite stringer system further comprises:
a. a foam core having a foam core top surface, a foam core bottom surface, a foam core right surface and a foam core left surface;
b. a composite stringer channel formed in the foam core, wherein the composite stringer channel is configured to receive the composite stringer;
c. a top laminated foam skin covering the foam core top surface, the foam core right surface and the foam core left surface, wherein the top laminated foam skin includes at least one layer of expanded foam;
d. a bottom laminated foam skin covering the foam core bottom surface, wherein the bottom laminated foam skin has at least one layer of expanded foam; and
e. a plastic plate laminated to a lower surface of the bottom laminated foam skin.

11. The composite stringer system set forth in claim 10, wherein the composite stringer is shorter than the foam core.

12. The break resistant composite stringer system of claim 10, wherein a second upper fibrous strip is adhered to stringer top surface, and wherein a second lower fibrous strip is adhered to the stringer lower surface.

13. The composite stringer system of claim 10, wherein the stringer body has a front end and a rear end, wherein the front end or the rear end is upturned so that it is an upturned end; wherein the upper fibrous strip is adhered to the stringer body from the front end to the rear end and wherein the lower fibrous strip is adhered to the stringer body from the front end to the rear end.

14. The composite stringer system set forth in claim 10, wherein the upper fibrous strip and the lower fibrous strip both have a length equal or shorter than the stringer body.

15. The composite stringer system set forth in claim 10, wherein the upper fibrous strip and the lower fibrous strip have a fibrous strip width dimension larger than a fibrous strip thickness dimension.

16. The composite stringer system set forth in claim 10, further including: an upper fibrous strip adhesive layer formed of a heat-activated rubber based adhesive wherein the upper fibrous strip adhesive layer is a heat resistant and waterproof adhesive layer interposed between the upper fibrous strip and the stringer top surface; and a lower fibrous strip adhesive layer formed of a heat-activated rubber based adhesive wherein the lower fibrous strip adhesive layer is a heat resistant and waterproof adhesive layer interposed between the lower fibrous strip and the stringer bottom surface.

17. The composite stringer system set forth in claim 16, wherein a second layer of heat resistant waterproof adhesive covers the fibrous strips and stringer body after the fibrous strips are bonded to the stringer body to form a composite stringer.

18. The composite stringer system set forth in claim 10, wherein the stringer body has a width in the range of 8 mm and 30 mm.

19. (canceled)

20. The composite stringer system set forth in claim 10, wherein the heat-activated rubber based adhesive comprises Styrene Butadiene Rubber (SBR), Acrylonitrile Butadiene Rubber (NBR), Polychloroprene Rubber (CR), Polybutadiene Rubber (BR), Polyisoprene Rubber (IR), Polyurethane (PU) and other hot melt adhesives.
